(19) United States
(12) Patent Application Publication
(10) Pub. No.: US 2012/0160814 A1
(43) Pub. Date: Jun. 28, 2012

(54) METHODS AND SYSTEMS FOR LINK PROCESSING USING LASER PULSES WITH OPTIMIZED TEMPORAL POWER PROFILES AND POLARIZATIONS

(75) Inventors: Yasu Osako, Lake Oswego, OR (US); Kelly J. Bruland, Portland, OR (US); Andrew Hooper, Portland, OR (US); Jim Dumestre, Tigard, OR (US); David Lord, Portland, OR (US)

(73) Assignee: ELECTRO SCIENTIFIC INDUSTRIES, INC., Portland, OR (US)

(21) Appl. No.: 12/980,131

(22) Filed: Dec. 28, 2010

(51) Int. Cl. B23K 26/00

(52) U.S. Cl. 219/121.61

(57) ABSTRACT

Systems and methods ablate electrically conductive links using laser pulses with optimized temporal power profiles and/or polarizations. In certain embodiments, the polarization property of a laser beam is set such that coupling between the laser beam and an electrically conductive link reduces the pulse energy required to ablate the electrically conductive link. In one such embodiment, the polarization is selected based on a depth of a target link structure. In another embodiment, the polarization changes as deeper material is removed from a target location. In addition, or in other embodiments, a first portion of a temporal power profile of a laser beam includes a rapid rise time to heat an upper portion of an electrically conductive link so as to form cracks in a passivation layer over upper corners of the electrically conductive link, without forming cracks at lower corners of the electrically conductive link.

### TECHNICAL FIELD

This disclosure relates generally to laser processing. In particular, this disclosure relates to using laser pulses with varying temporal power profiles and polarizations for laser processing of electrically conductive links on memory chips or other integrated circuit (IC) chips.

### BACKGROUND INFORMATION

Laser processing systems employed for processing memory devices, such as dynamic random access memory (DRAM), and other semiconductor devices commonly use a Q-switched diode pumped solid state laser. When processing memory devices, for example, a single laser pulse is commonly employed to sever an electrically conductive link structure. In other industrial applications, laser scribing is used to remove metal and dielectric semiconductor materials from a semiconductor device wafer prior to dicing. Lasers may also be used, for example, to trim resistance values of discrete and embedded components.

FIGS. 1A and 1B are example temporal pulse shapes of laser pulses generated by typical solid state lasers. The pulse shown in FIG. 1A may have been shaped by optical elements as is known in the art to produce a square-wave pulse. As shown in Table 1 and in FIGS. 1A and 1B, a typical solid state pulse shape is well described by its peak power, pulse energy (time integration of the power curve), and pulse width measured at a full-width half-maximum (FWHM) value. For the Gaussian laser pulse shown in FIG. 1B, for example, the pulse energy may be about 0.2 μJ and the pulse width may be about 20 ns for link processing. Thus, the peak power for this example is about 20 W.

Many memory devices and other semiconductor devices include a dielectric passivation material that covers the electrically conductive link. The overlying passivation material helps to contain the metallic link material so that it can be heated above an ablation threshold. For example, FIGS. 2A, 2B, 2C, and 2D are cross-sectional block diagrams of a semiconductor device 200 that includes passivated electrically conductive links 210, 212, 214. As shown in FIG. 1A, the semiconductor device 200 may include one or more layers of dielectric passivation material 216 formed over a semiconductor substrate 218. In this example, the semiconductor substrate 218 comprises silicon (Si), the dielectric material comprises silicon dioxide (SiO₂), and the electrically conductive links 210, 212, 214 comprise Aluminum (Al). Generally, the electrically conductive links 210, 212, 214 are located within the dielectric material 216. In other words, the dielectric material is adjacent to both top and bottom surfaces of the electrically conductive links 210, 212, 214 such that the electrically conductive links 210, 212, 214 are not directly exposed to a processing laser beam 220. Rather, the laser beam 220 passes through an overlying portion of the dielectric passivation material 216 before interacting with a selected electrically conductive link 212.

In FIG. 2A, interaction between the laser beam 220 and the selected electrically conductive link 212 causes the electrically conductive link 212 to heat up. Heating causes pressure inside the electrically conductive link 212 to increase. The dielectric passivation material 216 traps the heat and prevents portions of the heated electrically conductive link 212 from being ejected onto the adjacent electrically conductive links 210, 214. In other words, the dielectric passivation material 216 prevents liquefied portions of the electrically conductive link 212 from “splashing” onto other portions of the semiconductor device 200. However, it may be difficult to sufficiently control passivation thickness. Thus, the thickness of the dielectric passivation material overlying the electrically conductive link 212 may vary inside the wafer and from wafer to wafer, which may affect process consistency and yield.

For illustrative purposes, FIG. 2B shows an enlarged view of a portion of the dielectric passivation material 216 surrounding the electrically conductive link 212. As shown in FIG. 2B, continued heating may cause cracks 222 to open from upper corners of the electrically conductive link 212. The difference in linear expansion between dielectrics (e.g., SiO₂ or SiN) and metals (e.g., Cu or Al), may be around 100 times. Thus, the large difference in linear expansion leads to stress and cracks 222 in the dielectric passivation material 216.

Once the electrically conductive link 212 reaches an ablation threshold, as shown in FIG. 2C, the electrically conductive link 212 may explode, which may cause the overlying dielectric passivation material 216 and portions of the electrically conductive link 212 to be removed as vapor 224. As shown in FIG. 2D, the laser beam 220 may then clean out remaining portions of the electrically conductive link 212, if any, through boiling, melting, and/or splashing.

Although not shown in FIGS. 2A, 2B, 2C, and 2D, some link processing applications also cause cracks to open in the dielectric passivation material from lower corners of the electrically conductive link 212. Such cracks increase the damage risk to the semiconductor device, including creating an irregular or over-sized opening in the overlying passivation layer, damaging neighboring link(s), and damaging the underlying silicon substrate.

For example, to illustrate the difference in opening sizes based on crack locations, FIGS. 3A and 3B are cross-sectional block diagrams of an electrically conductive link 310 within a dielectric passivation material 312. In this example, the electrically conductive link 310 comprises copper (Cu) and the dielectric passivation material 312 comprises SiO₂. The dashed lines in FIG. 3A represent overlying cracks 314 extending from upper corners of the electrically conductive link 310 through the dielectric passivation material 312. After ablation of the electrically conductive link 310, a portion of the dielectric passivation material 312 has been removed roughly along the locations of the overlying cracks 314 to form an opening 316. The dashed lines in FIG. 3B represent underlying cracks 318 extending from lower corners of the electrically conductive link 310 through the dielectric passivation material 312. After ablation of the electrically conductive link 310, a portion of the dielectric passivation material 312 has been removed roughly along the locations of the underlying cracks 318 to form an opening 320. The opening 320 that results from the underlying cracks 318 is substantially larger than the opening 316 that results from the overlying cracks 314. The large opening 320 may damage adjacent links (not shown). Thus, crack formation at the lower corners of electrically conductive links should be avoided.

### SUMMARY OF THE DISCLOSURE

Systems and methods ablate electrically conductive links using laser pulses with optimized temporal power profiles and/or polarizations. In certain embodiments, the polarization property of a laser beam is set such that coupling between the laser beam and an electrically conductive link reduces the pulse energy required to ablate the electrically conductive link. In one such embodiment, the polarization is selected based on a depth of a target link structure. In another embodiment, the polarization changes as deeper material is removed from a target location. In addition, or in other embodiments, a first portion of a temporal power profile of a laser beam includes a rapid rise time to heat an upper portion of an electrically conductive link so as to form cracks in a passivation layer over upper corners of the electrically conductive link, without forming cracks at lower corners of the electrically conductive link.

In one embodiment, a laser-based processing method removes target material from selected electrically conductive link structures of redundant memory or integrated circuitry, wherein each selected link structure has opposite side surfaces and top and bottom surfaces, the top and bottom surfaces being separated by a distance that defines a link depth. The method includes generating a burst of laser pulses, selectively setting one or more first pulses in a first burst of laser pulses to a first polarization based on a depth of a first target link structure, and directing the first burst of laser pulses to the first target link structure to ablate at least a first portion of the first target link structure. In certain such embodiments, the method also includes selectively setting one or more second pulses in a second burst of laser pulses to a second polarization based on a depth of a second target link structure, and directing the second burst of laser pulses to the second target link structure. The first polarization may be radial polarization and the second polarization may be azimuthal polarization, and the depth of the first target link structure may be less than the depth of the second target link structure. In other such embodiments, before directing the first burst of laser pulses to the first target link structure, the method includes selectively setting one or more second pulses in the first burst of laser pulses to a second polarization to ablate a second portion of the target link structure, wherein the second portion of the link structure may be deeper than the first portion of the link structure.

In another embodiment, a laser-based processing method removes target material from selected electrically conductive link structures of redundant memory or integrated circuitry, each selected link structure having opposite side surfaces and top and bottom surfaces, the top and bottom surfaces being separated by a distance that defines a link depth. The method includes generating a burst of laser pulses, selectively setting one or more first pulses in the burst of laser pulses to a first polarization, selectively setting one or more second pulses in the burst of laser pulses to a second polarization, and directing the burst of laser pulses to a target link structure.

In another embodiment, a laser-based processing method for removes target material from selected electrically conductive link structures of redundant memory or integrated circuitry, each selected link structure having opposite side surfaces and top and bottom surfaces, the top and bottom surfaces being separated by a distance that defines a link depth, wherein the top surface of each selected link structure is adjacent overlying passivation material and the bottom surface of each selected link structure is adjacent underlying passivation material. The method includes generating a burst of laser pulses, selectively adjusting one or more first pulses in the burst of laser pulses to a first amplitude selected so as to crack the overlying passivation material at top corners of the target link structure without cracking the underlying passivation material, and selectively adjusting a plurality of second pulses in the burst of laser pulses at successively higher second amplitudes that ramp up so as to gradually heat the first target link structure above an ablation threshold. Each of the respective second amplitudes is less than the first amplitude. The method also includes directing the burst of laser pulses to a target link structure. In certain such embodiments, the method also includes selectively adjusting a plurality of third pulses in the burst of laser pulses at a constant third amplitude, wherein the third amplitude is less than the first amplitude. In addition, or in other embodiments, the method may further include selectively adjusting a plurality of fourth pulses in the burst of laser pulses at successively lesser fourth amplitudes that ramp down to remove a residue of the target link structure.

Additional aspects and advantages will be apparent from the following detailed description of preferred embodiments, which proceeds with reference to the accompanying drawings.

### BRIEF DESCRIPTION OF THE DRAWINGS

FIGS. 1A and 1B are example temporal pulse shapes of laser pulses generated by typical solid state lasers.

FIGS. 2A, 2B, 2C, and 2D are cross-sectional block diagrams of a semiconductor device that includes passivated electrically conductive links.

FIGS. 3A and 3B are cross-sectional block diagrams of an electrically conductive link within a dielectric passivation material.

FIG. 4 is a table showing the thermal dependence of light absorption for copper.

FIG. 5 illustrates graphs of the thermal dependence of light absorption for aluminum.

FIG. 6 is a block diagram of an example system for generating a stable train of laser pulses from a CW laser according to one embodiment.

FIG. 7 schematically illustrates the CW laser beam and laser pulse train shown in FIG. 6 according to one embodiment.

FIG. 8A schematically illustrates an electrically conductive link processed with a laser beam comprising a long pulse.

FIG. 8B schematically illustrates the electrically conductive link processed with a laser beam that includes a short pulse according to one embodiment.

FIG. 9 is a block diagram of an example system for generating tailored bursts of short or ultrashort laser pulses according to one embodiment.

FIGS. 10A, 10B, and 10C schematically illustrate the mode-locked laser pulses and tailored bursts of laser pulses shown in FIG. 9 according to certain embodiments.

FIG. 11 is a block diagram of a laser processing system for selectively setting the polarization of laser pulses according to one embodiment.

FIG. 12 is a flow chart of a method for laser processing with selective polarizations according to one embodiment.

FIG. 13 schematically illustrates the processing of a wafer having electrically conductive links according to one embodiment.

FIG. 14 is a flow chart of a method for laser processing with selective polarizations according to another embodiment.

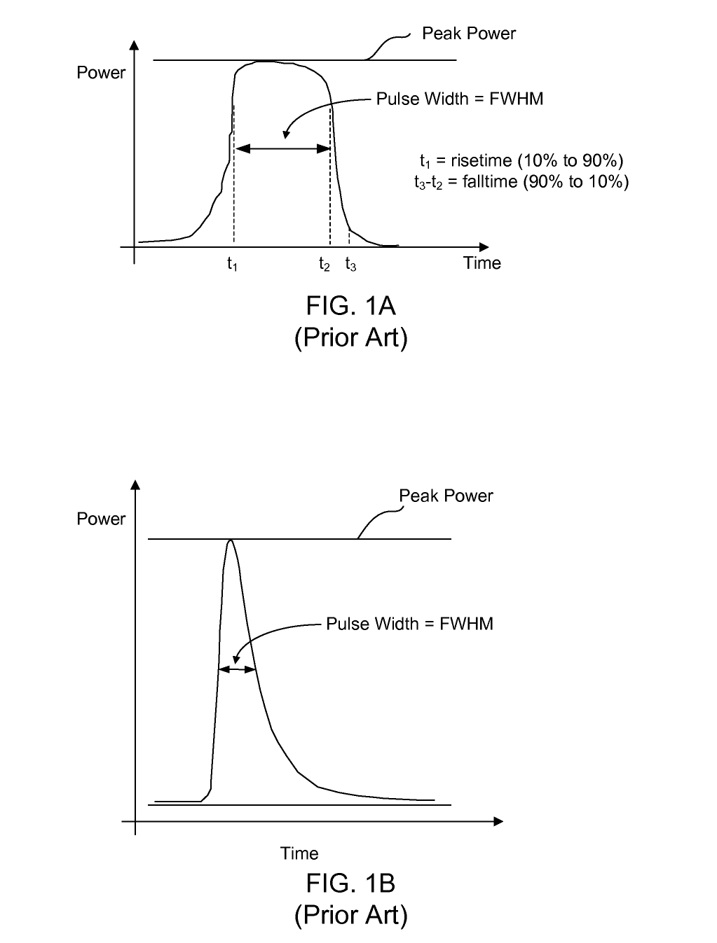

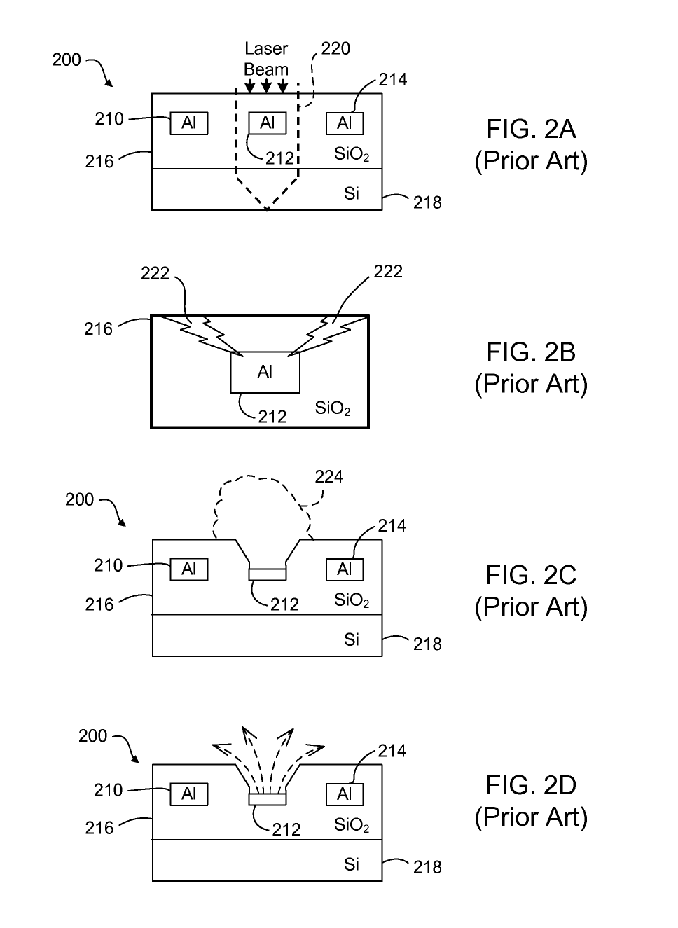

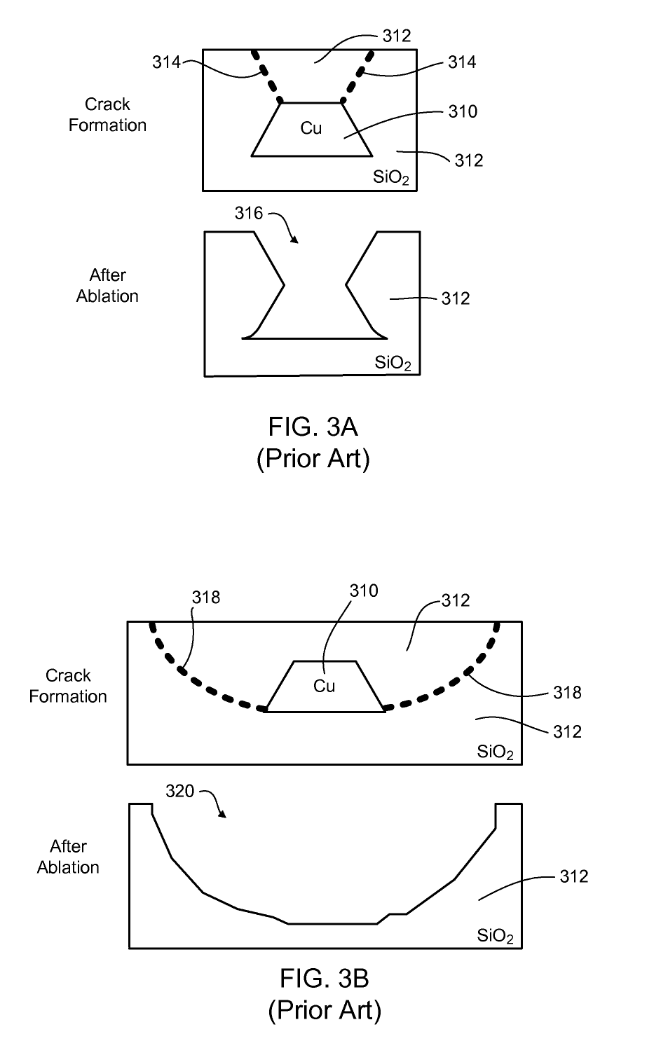

### DETAILED DESCRIPTION OF PREFERRED EMBODIMENTS

This disclosure provides systems and methods for effectively and reliably ablating electrically conductive links using laser pulses with optimized temporal power profiles and/or polarizations. In certain embodiments, the polarization property of a laser beam is set such that coupling between the laser beam and an electrically conductive link reduces the pulse energy required to ablate the electrically conductive link. In one such embodiment, the polarization is selected based on a depth of a target link structure. In another embodiment, the polarization changes as deeper material is removed from a target location.

In addition, or in other embodiments, a first portion of a temporal power profile of a laser beam includes a rapid rise time to heat an upper portion of an electrically conductive link so as to form cracks in a passivation layer over upper corners of the electrically conductive link, without forming cracks at lower corners of the electrically conductive link. The embodiments disclosed herein adapt to varying thicknesses in the passivation layer within a wafer or between wafers. After crack formation, the temporal power profile is reduced and slowly rises to gradually heat the electrically conductive link. As discussed below, laser absorption of a material increases as the material's temperature increases. The slow rise of the temporal power profile improves coupling between the laser beam and the electrically conductive link. Further, the gradual heating mitigates stress around the interface between the electrically conductive link and the passivation material during ablation by allowing the heat to propagate to the surrounding passivation layer. In certain embodiments, the slow rise in the temporal power profile is followed by a temporally flat portion to secure the ablation and/or a gradual decline in the temporal power profile to clean up any residue of the electrically conductive link.

In certain embodiments, the desired temporal power profile is generated using a fast optical modulator such as an electro-optic modulator (EOM) or an acousto-optic modulator (AOM) and a continuous wave (CW) or a mode-locked laser.

Reference is now made to the figures in which like reference numerals refer to like elements. For clarity, the first digit of a reference numeral indicates the figure number in which the corresponding element is first used. In the following description, numerous specific details are provided for a thorough understanding of the embodiments of the invention. However, those skilled in the art will recognize that the invention can be practiced without one or more of the specific details, or with other methods, components, or materials. Further, in some cases, well-known structures, materials, or operations are not shown or described in detail in order to avoid obscuring aspects of the invention. Furthermore, the described features, structures, or characteristics may be combined in any suitable manner in one or more embodiments.

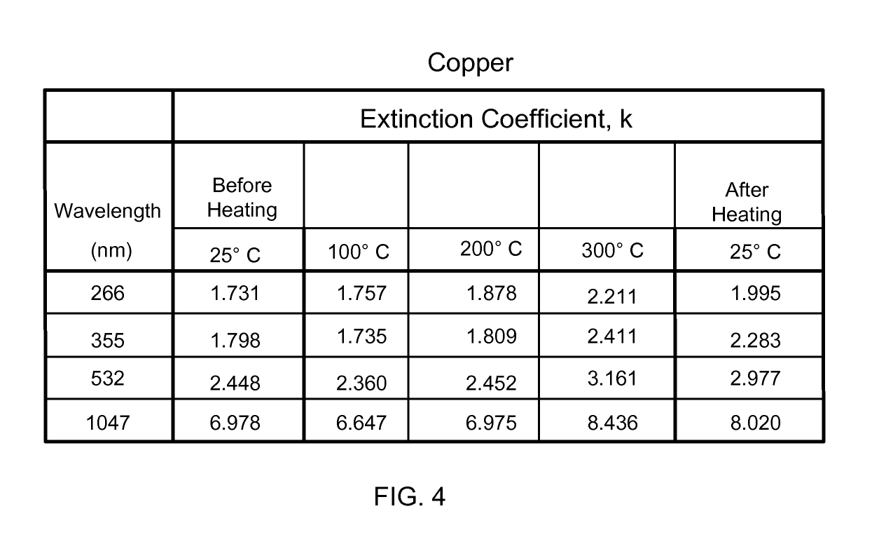

As discussed above, laser absorption of a material increases as the material's temperature increases. FIG. 4, for example, is a table showing the thermal dependence of light absorption for copper. The table shows the extinction coefficient, k, for copper for various laser beam wavelengths (266 nm, 355 nm, 532 nm, and 1047 nm) and temperatures (25° C. (both before and after heating), 100° C., 200° C., and 300° C.). As those skilled in the art will recognize, the extinction coefficient, k, is a parameter corresponding to how strongly a substance absorbs light at a given wavelength. As shown in FIG. 4, the extinction coefficient, k, for copper increases at each displayed wavelength as the temperature increases.

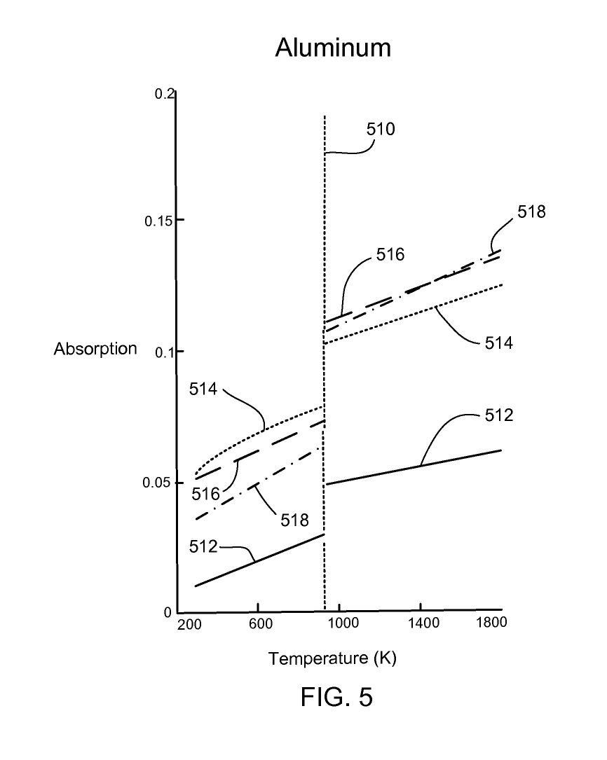

As another example, FIG. 5 illustrates graphs of the thermal dependence of light absorption for aluminum. The dashed vertical line 510 represents a transition between solid and liquid states of aluminum. The graphs 512 represent aluminum's absorption of light at a wavelength of 10.6 μm. The graphs 514 represent aluminum's absorption of light at a wavelength of 1.064 μm. The graphs 516 represent aluminum's absorption of light at a wavelength of 0.53 μm. The graphs 518 represent aluminum's absorption of light at a wavelength of 0.355 μm. As shown in FIG. 5, aluminum's absorption of light at each of the displayed wavelengths increases with temperature. Thus, certain embodiments described herein gradually increase a laser beam's temporal power profile to improve coupling between the laser beam and electrically conductive links.

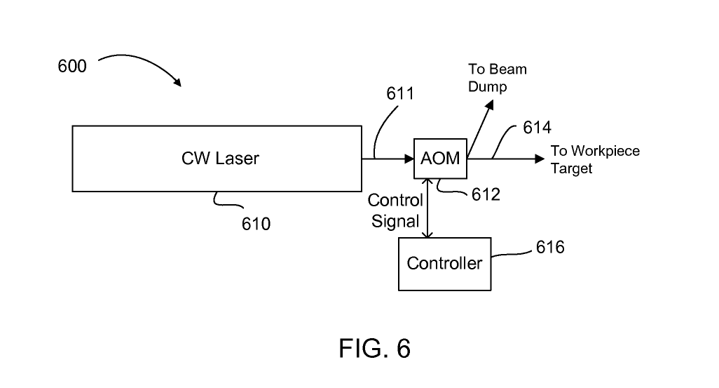

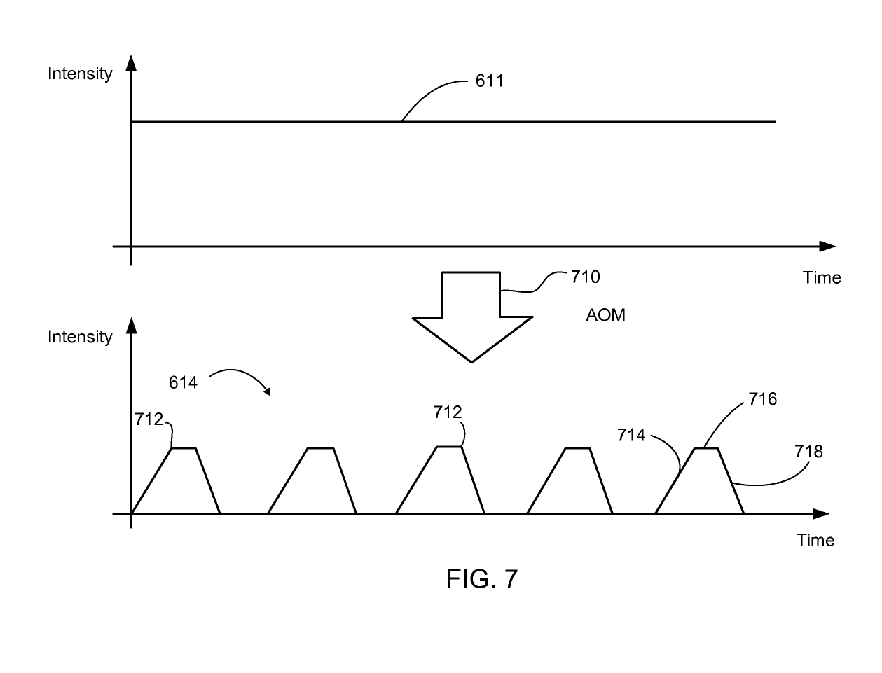

FIG. 6 is a block diagram of an example system 600 for generating a stable train of laser pulses from a CW laser 610 according to one embodiment. The CW laser 610 outputs a CW laser beam 611 with a wavelength in a range between about 1.0 μm and about 1.3 μm and an output power up to about 20 W. The CW laser 610 may include, for example, a yttrium aluminum garnet (YAG) laser or a vanadate (YVO₄) laser. The system 600 includes an AOM 612 that receives the CW laser beam 611 from the CW laser 610 and converts the CW laser beam 611 into a laser pulse train 614 comprising a series of shaped laser pulses (see FIG. 7). Other embodiments may use an EOM instead of, or in addition to, the AOM 612. The AOM 612 directs the laser pulse train 614 along an optical path toward a workpiece target (e.g., a target link structure location). The AOM 612 deflects unused portions of the CW laser beam to a beam dump. The AOM 612 also shapes the individual laser pulses of the laser pulse train 614 for a desired temporal power profile. The system 600 may include a controller 616 comprising one or more processors (not shown) for selecting and controlling the modulation (e.g., the shape of each laser pulse) provided by the AOM 612.

FIG. 7 schematically illustrates the CW laser beam 611 and laser pulse train 614 shown in FIG. 6 according to one embodiment. For illustrative purposes, the process of converting the CW laser beam 611 to the laser pulse train 614 using the AOM 612 is represented by an arrow 710. The temporal power profile (i.e., intensity vs. time) of the CW laser beam 611 is constant and the temporal power profile of the laser pulse train 614 varies in a series of individual laser pulses 712 (five shown). Each laser pulse 712 may be directed to a different target location (e.g., link structure) on a workpiece.

Each laser pulse 712 includes a first portion 714 having a slow rise time in a range between 0.002 μs and 0.01 μs, a second portion 716 that has substantially constant power lasting between 0.002 μs and 0.1 μs, and a third portion 718 having a fall time between 0.002 μs and 0.01 μs. The first portion 714 may gradually heat the electrically conductive link so as to ablate the link and open the overlying passivation layer. The second portion 716 and the third portion 718 may not be necessary in every embodiment. In the embodiment shown in FIG. 7, however, the second portion 716 provides additional energy to ablate the link and the third portion 718 removes metallic residue to ensure electrical disconnection of the link.

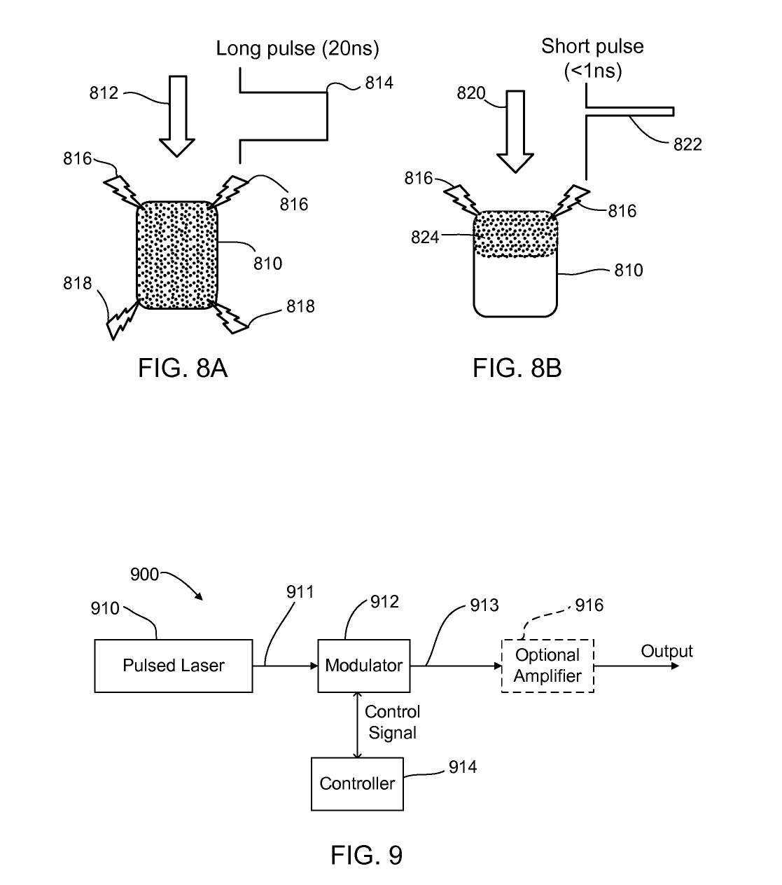

As discussed above, the slow rise time of the first portion 714 of the laser pulse 712 is selected to avoid cracks in underlying passivation material at lower corners of the electrically conductive links. In certain link processing applications, however, the overall duration of each pulse 712 in the laser pulse train 614 may also cause cracks at the lower corners of the electrically conductive links. For example, FIG. 8A schematically illustrates an electrically conductive link 810 processed with a laser beam 812 comprising a long pulse 814 (e.g., 20 ns). For illustrative purposes, dielectric passivation material is not shown. As illustrated by the shading of the entire electrically conductive link 810, the long pulse 814 may cause the entire electrically conductive link 810 to heat up to the point where both overlying cracks 816 extend through the dielectric passivation material from the upper corners of the electrically conductive link 810 and underlying cracks 818 extend through the dielectric passivation material from the lower corners of the electrically conductive link 810. Note that the upper corners and the lower corners of the electrically conductive link 810 are described with respect to the propagation direction of the laser beam 812 (i.e., the laser beam 812 passes from an upper surface to a lower surface of the link 810). As discussed above, the underlying cracks 818 reduce processing quality and yield.

FIG. 8B schematically illustrates the electrically conductive link 810 processed with a laser beam 820 that includes a short pulse 822 (e.g., less than about 1 ns) according to one embodiment. As with FIG. 8A, for illustrative purposes, dielectric passivation material is not shown in FIG. 8B. As illustrated by the shading of only an upper portion 824 of the electrically conductive link 810, the short pulse 822 may heat only the upper portion 824 of the electrically conductive link 810 so as to form the overlying cracks 816 extending through the dielectric passivation material from the upper corners of the electrically conductive link 810. However, the short pulse 822 does not heat the remainder of the electrically conductive link 810. Thus, the short pulse 822 does not cause underlying cracks to extend from the lower corners of the electrically conductive link 810. Skilled persons will recognize from the disclosure herein that two or more short pulses may also be used in some embodiments to form the overlying cracks 816 without also forming underlying cracks 818.

The temporal pulse width of a laser pulse used to create overlying cracks 816 extending through the dielectric passivation material from the upper corners of the electrically conductive link 810 without causing the underlying cracks 818 depends on factors such as the specific material used for the electrically conductive link 810 and the thickness (e.g., depth) of the electrically conductive link 810. The heat affected zone (HAZ) is the extent by which heat affects a workpiece and may be described by:

HAZ=2*(thermal diffusivity*pulse width)̂(½).

As the calculation for HAZ shows, when the thickness of an electrically conductive link is less than about 1 μm, a pulse width as short as a few hundred picoseconds may be needed to localize the heat in the upper part of the electrically conductive link. For example, when a copper link thickness is about 0.4 μm, the upper portion of the copper link may be heated using a laser pulse with a pulse width of about 100 ps without creating underlying cracks. If the laser pulse is longer than about 100 ps, however, thermal stress is generated not only at the upper corners but also the lower corners of the copper link and subsequent link ablation reduces the yield due to the creation of a large opening, chipping, and/or cracking. As another example, a laser pulse having a temporal pulse width less than about 30 ps may be required to process a copper link having a thickness of about 0.2 μm without causing underlying cracks at the lower corners of the copper link.

The external AOM 612 (or an external EOM) shown in FIG. 6 may not have the modulation speed necessary to produce a 30 ps laser pulse from the CW laser beam 611, as discussed in the above example. Thus, in certain embodiments discussed below, a pulsed laser beam (e.g., produced by a picosecond, mode-locked laser) is provided to an external EOM or AOM to generate tailored bursts laser pulses.

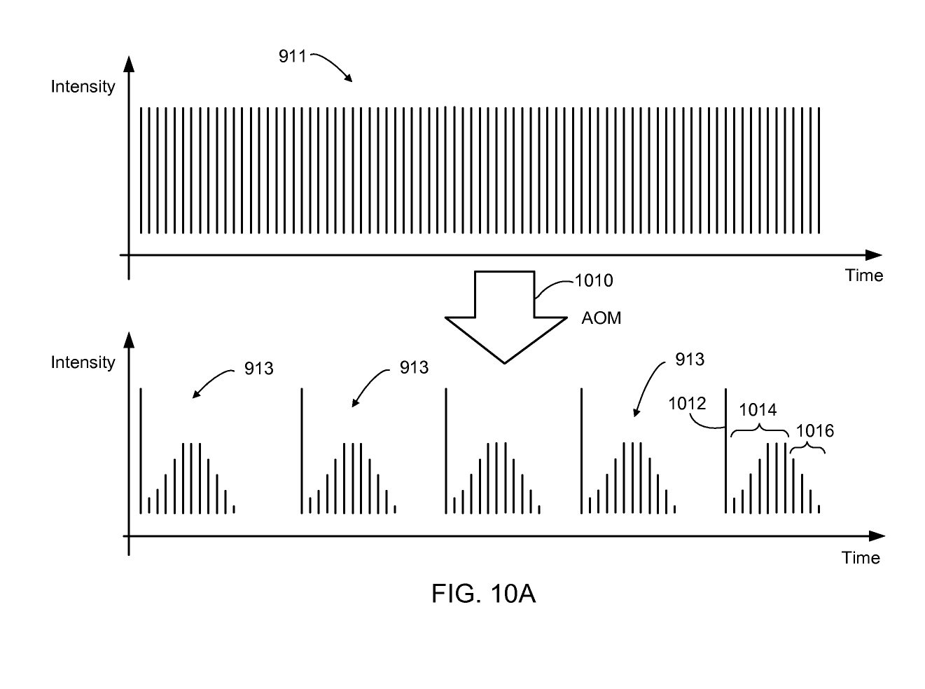

FIG. 9 is a block diagram of an example system 900 for generating tailored bursts of short or ultrashort laser pulses according to one embodiment. The laser system 900 includes a pulsed laser 910, a modulator 912, and a controller 914. The system 900 may also include an optional amplifier 916. The pulsed laser 910 generates a series of short or ultrashort, mode-locked laser pulses 911. The pulsed laser 910 may include, for example, a diode pumped solid state laser or a fiber laser. The modulator 912 amplitude modulates the mode-locked laser pulses 911 provided by the pulsed laser 910 to provide a tailored burst of laser pulses 913 having an envelope with a desired temporal power profile. The optional amplifier 916 amplifies the tailored burst of laser pulses 913 provided by the modulator 912.

The modulator 912 may include, for example, an AOM or an EOM. Using an AOM having a response time of about 1 ns or more, the diffraction efficiency of the mode-locked laser pulses can be modulated for optimal temporal pulse shape to generate cracks over the electrically conductive link so as to ablate and remove the electrically conductive link. The modulation is based on a control signal received from the controller 914. Thus, the controller 914 may be programmed with a desired burst envelope for a particular application or target type. In addition to controlling the burst envelope's amplitude and particular shape, the modulator 912 may also be programmed in certain embodiments to control the temporal spacing of the laser pulses under the envelope and/or the burst envelope's overall temporal width. The programmable burst envelope may be obtained by using, for example, pulse picking (e.g., selecting pulses so as to control the distance between pulses or the pulse repetition frequency).

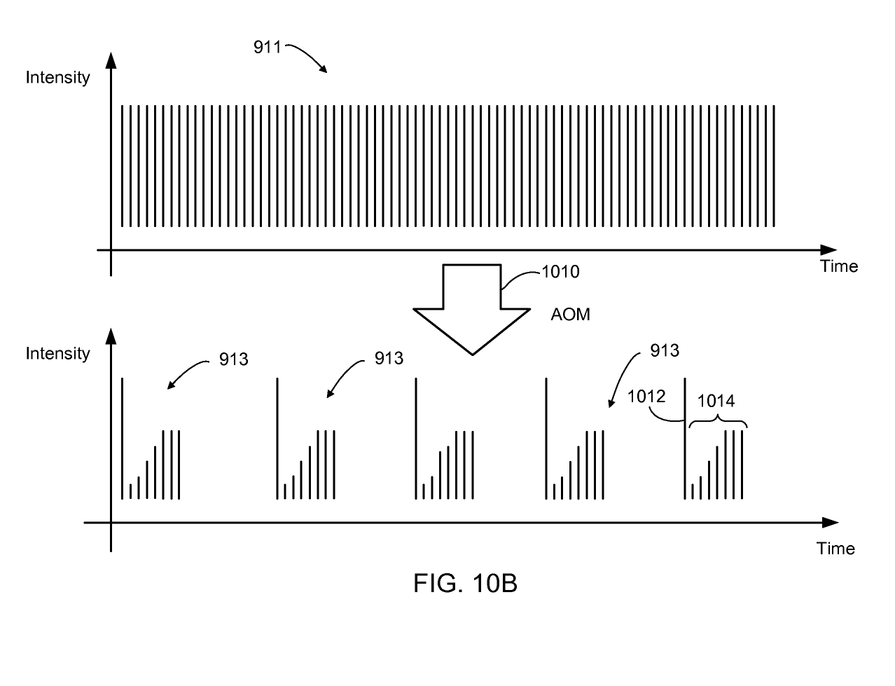

FIGS. 10A, 10B, and 10C schematically illustrate the mode-locked laser pulses 911 and tailored bursts of laser pulses 913 shown in FIG. 9 according to certain embodiments. For illustrative purposes only, FIGS. 10A, 10B, and 10C each show five separate tailored bursts of laser pulses 913. In certain embodiments, each burst 913 may be directed to a separate target location (e.g., link structure) on a workpiece. Also for illustrative purposes in FIGS. 10A, 10B, and 10C, the process of converting the mode-locked laser pulses 911 to the tailored bursts of laser pulses 913 using the modulator 912 (e.g., AOM) is represented by an arrow 1010.

Each of the mode-locked laser pulses 911 has a temporal pulse width that is less than approximately 1 ns. In an example embodiment, each of the mode-locked laser pulses 911 has a temporal pulse width in a range between about 10 ps and about 20 ps at a repetition rate of about 80 MHz. The repetition rate for a mode-locked laser may be determined by the cavity length. However, a master oscillator power amplifier (MOPA) configuration with a pulse picker, for example, may be run at any repetition rate depending on the response time of the pulse picker. For example, if the pulse picker is an EOM, the repetition rate may be in a range between about 1 Hz and about 10 MHz. In another embodiment, each of the mode-locked laser pulses 911 has a temporal pulse width in a range between about 1 ns and about 100 fs. Temporal pulse widths that are less than about 10 ps may be referred to herein as “ultrashort” or “ultrafast” laser pulses.

The temporal width of the burst envelope of each tailored burst of laser pulses 913, according to one embodiment, is in a range between about 10 ps and about 1 ns. In other embodiments, the temporal width of the burst envelope is in a range between about 1 ns and about 10 ns. In other embodiments, the temporal width of the burst envelope is in a range between about 10 ns and about 100 ns. In other embodiments, the temporal width of the burst envelope is in a range between about 100 ns and about 1 ms. The burst envelope may have other temporal widths depending on the particular application.

In FIG. 10A and 10B, each tailored burst of laser pulses 913 includes one or more first pulses 1012 having an amplitude selected so as to generate cracks in the dielectric passivation material over the electrically conductive link. In one embodiment, the pulse energy of the first pulse 1012 is in a range between about 0.1 μJ and about 0.02 μJ. In certain such embodiments, the temporal pulse width of the first pulse 1012 is shorter than the other pulses in the tailored burst of laser pulses 913 so as to localize the thermal energy in the upper portion of the electrically conductive link. For example, for an electrically conductive link having a depth of about 1 μm, the first pulse 1012 may have a temporal pulse width of about 0.5 ns while the remaining pulses in the burst 913 each have a temporal pulse width of about 1 ns or longer (e.g., to ensure that the entire fuse is heated and blown). Thus, in certain embodiments, the first pulse 1012 may be twice as high as any of the remaining pulses within the burst of laser pulses 913. For illustrative purposes FIGS. 10A and 10B show a single first pulse 1012 having an amplitude that is substantially larger than the other pulses in the particular burst of laser pulses 913. However, two or more first pulses 1012 may also be used in each burst depending on the particular application. The amplitude of the one or more first pulses 1012 may depend on the thickness of the overlying passivation layer, the volume of the link, and/or the particular materials used for the passivation layer and electrically conductive link.

As also shown in FIGS. 10A and 10B, the one or more first pulses 1012 are followed by a group of second pulses 1014 to heat up and ablate the electrically conductive link. Each pulse in the group of second pulses 1014 has a respective amplitude that is lower than the one or more first pulses 1012. A plurality of pulses in the group of second laser pulses 1014 have amplitudes that gradually increase in time with respect to one another. The gradual increase in pulse amplitude gently heats up the electrically conductive link to improve laser beam absorption so as to ablate the electrically conductive link with a reduced dose of laser energy and with reduced stress to the dielectric passivation material near the lower corners of the electrically conductive link. The temporal width (e.g., the number of pulses based on the pulse repetition rate) of the group of second laser pulses 1014 and/or the slope (e.g., the rise time) of the gradually increasing amplitudes may be selected based on the particular materials being processed, the volume of the electrically conductive link, and/or the thickness of the passivation laser overlying the electrically conductive link.

After ablation of the electrically conductive link, some metallic residue may need to be removed to ensure electrical disconnection. As shown in FIG. 10A, a group of third laser pulses 1016 may be applied to the target location without the overlying passivation layer (which has been blown off during ablation of the electrically conductive link) so as to remove the metallic residue. As shown in the example in FIG. 10A, a plurality of pulses in the group of third pulses 1016 have amplitudes that gradually decrease in time with respect to one another so as to reduce the amount of heat dissipated to surrounding materials as less residue remains at the target location during smooth cleaning. To reduce or eliminate thermal effects in surrounding materials, the example embodiment shown in FIG. 10B does not include the group of third pulses so as. Further, the removal of metallic residue may not be needed in all applications.

In FIG. 10C, each tailored burst of laser pulses 913 includes the group of second pulses 1014 and the group of third pulses 1016 discussed above, but does not include the large first pulse 1012 shown in FIGS. 10A and 10B. The embodiments shown in FIGS. 10A and 10B may be useful, for example, where a low-k dielectric or other passivation material is substantially transparent to the burst of pulses. The embodiment shown in FIG. 10C, on the other hand, may be useful when the low-k dielectric or other passivation material overlying the electrically conductive link absorbs at least a portion of the laser pulse in the burst. In this situation, a large initial pulse may not be needed to crack the overlying passivation layer because the tailored burst of laser pulses 913 starts ablating the overlying passivation layer as the metallic link begins to heat.

Using multiple laser pulses, as shown in FIGS. 10A, 10B, and 10C, to process links decreases the ablation threshold of the electrically conductive link in a process referred to as incubation. Fluence below the ablation threshold can affect metals and other materials such that the ablation threshold for the next pulse decreases to a degree that depends on the type of material. The following equation describes the incubation phenomenon:

Fth(n)=Fth(1)*n̂(s−1),

where Fth(1) is the ablation threshold for a single pulse, Fth(n) is the ablation threshold for n pulses, and s is the incubation factor.

As discussed above, in certain embodiments the polarization property of a laser beam is set such that coupling between the laser beam and an electrically conductive link reduces the pulse energy required to ablate the electrically conductive link. Such embodiments may be used alone or with any of the temporal power profile shaping embodiments discussed above during link processing. In one embodiment, the polarization is selected based on a depth of a target link structure. In another embodiment, the polarization changes as deeper material is removed from a target location.

Using a radially or azimuthally polarized laser beam provides improved coupling between the laser beam and metallic links so as to mitigate excessive ablation that leads to narrowing the process window. Depending on the fluence and the type of metal, either radial or azimuthal polarization may be used. The coupling between the metal link and the laser beam depends on the polarization as well as multi-reflection along the kerf created by laser ablation. Radially polarized laser beams provide better coupling with materials at relatively low fluence. However, for higher fluences, the multi-reflection by azimuthally polarized laser beams starts to play a role. In either case, radially or azimuthally polarized laser beams ablate metals more effectively than circularly or linearly polarized laser beams. In certain embodiments, radial polarization is used for target structures that are relatively thin or for top layers of a target structure. For relatively deeper target structures, or for lower layers of a target structure where the upper layer(s) has been removed, azimuthal polarization is used.

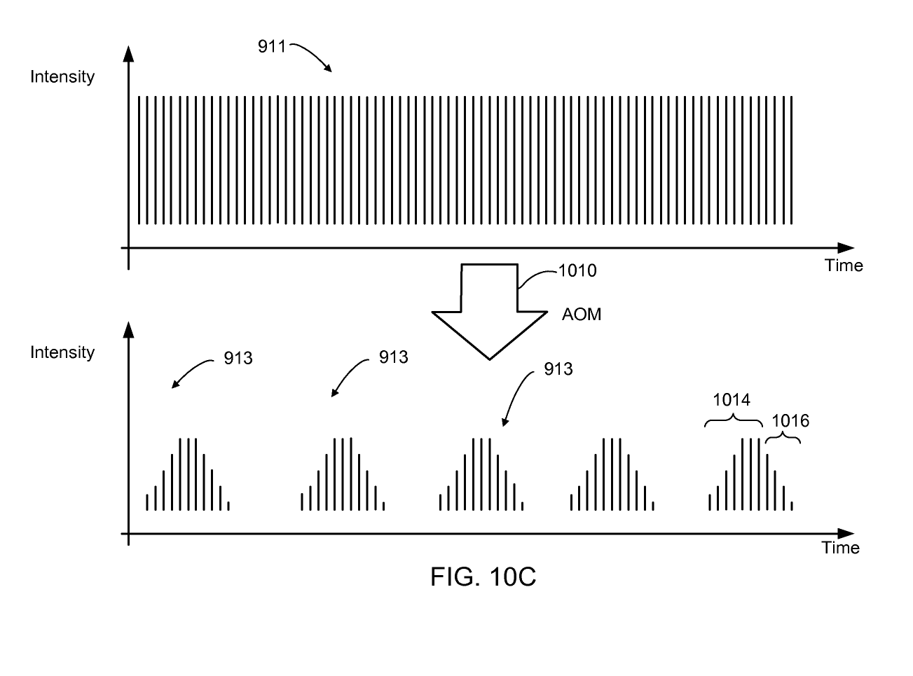

FIG. 11 is a block diagram of a laser processing system 1100 for selectively setting the polarization of laser pulses according to one embodiment. The system 1100 includes a pulsed laser 1110, a modulator 1112, and a path selector 1114. The pulsed laser 1110 generates a series of short or ultrashort, mode-locked laser pulses, such as the laser pulses 911 discussed above with respect to FIGS. 9, 10A, 10B, and 10C. The pulsed laser 1110 may include, for example, a diode pumped solid state laser or a fiber laser. The modulator 1112 amplitude modulates the mode-locked laser pulses provided by the pulsed laser 1110 to provide a tailored burst of laser pulses having an envelope with a desired temporal power profile, as discussed above. The modulator 912 may include, for example, an AOM or an EOM. Although not shown, the system 1100 may also include an amplifier, such as the optional amplifier 916 shown in FIG. 9.

The path selector 1114 may be selected from, for example, a manually adjustable mirror, a fast steering mirror, an electro-optic deflector, or an acousto-optic deflector. The path selector 1114 selectively directs the output of the modulator 1112 along a first beam path including a radial polarizer 1116 or a second beam path including an azimuthal polarizer 1118. In certain embodiments, the path selector 1114 may be under the control of controller 1120 for on-the-fly path selection based on a depth of a particular target or to change the polarization as layers of a target are removed. The controller 1120 may include one or more processors (not shown) for processing computer executable instructions stored on a computer readable storage medium. As discussed above, the controller 1120 may also be used for controlling the modulator 1112 for selecting a desired temporal power profile for the burst of laser pulses. The system 1100 includes a beam combiner for combining the two beam paths and mirrors 1124, 1126 to direct the laser beam along at least one of the beam paths. The radial polarizer 1116 may include, for example, an LMR-1064 radial polarization output coupler, a PLR-1064 radial polarizer, or an SWP-1064 polarization converter, which are each available from Photonic Lattice, Inc. of Sendai City, Japan. The azimuthal polarizer 1118 may include, for example, an LMA-1064 azimuthal polarizer output coupler, a PLA-1064 azimuthal polarizer, or the SWP-1064 polarization converter, which are available from Photonic Lattice, Inc.

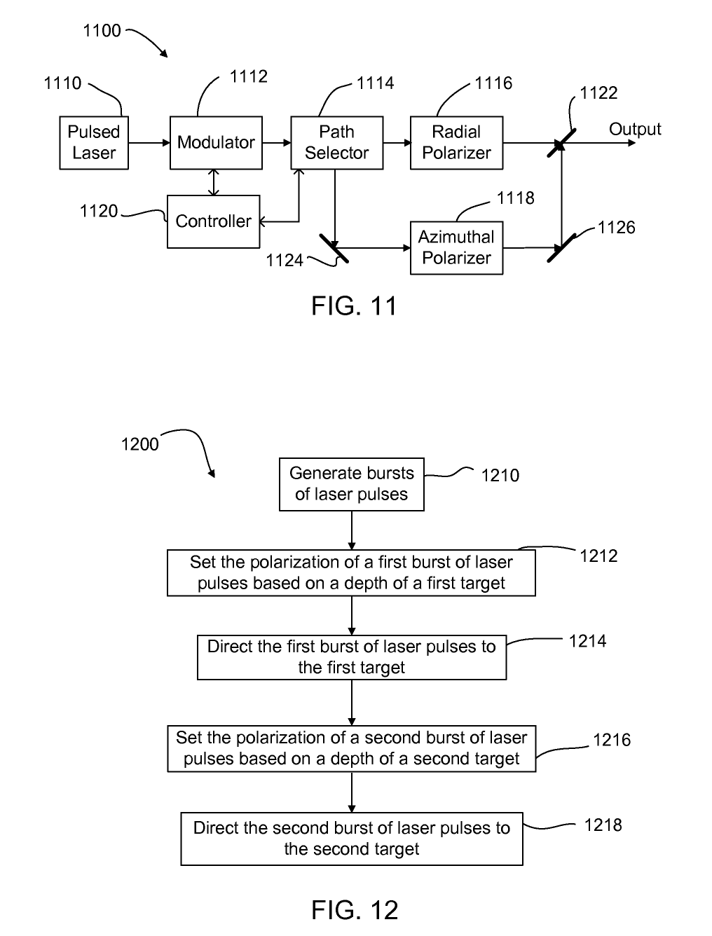

FIG. 12 is a flow chart of a method 1200 for laser processing with selective polarizations according to one embodiment. The method 1200 includes generating 1210 bursts of laser pulses. The method 1200 also includes setting 1212 the polarization of a first burst of laser pulses based on a depth of a first target and directing 1214 the first burst of laser pulses to the first target. If the first target is relatively thick, then the first burst of laser pulses may be azimuthally polarized. On the other hand, if the first target is relatively thin, then the first burst of pulses may be radially polarized. For example, a laser beam with a wavelength λ of about 1 μm and a spot size of about 1 μm has a confocal parameter (i.e., (2π*wₒ²)/λ, where wₒ is the radius of the spot) of about 1.6 μm. Thus, multi-reflections within the kerf created by the laser beam may be substantial at a depth of about 2 μm. Accordingly, in this example, the first burst of laser pulses is radially polarized if the target thickness is less than 2 μm, and the first burst of laser pulses is azimuthally polarized if the target thickness is greater than or equal to 2 μm.

The method 1200 further includes setting 1216 the polarization of a second burst of laser pulses based on a depth of a second target and directing 1218 the second burst of laser pulses to the second target. If the second target is relatively thick, then the second burst of laser pulses may be azimuthally polarized. On the other hand, if the second burst of laser pulses is relatively thin, then the second burst of pulses may be radially polarized.

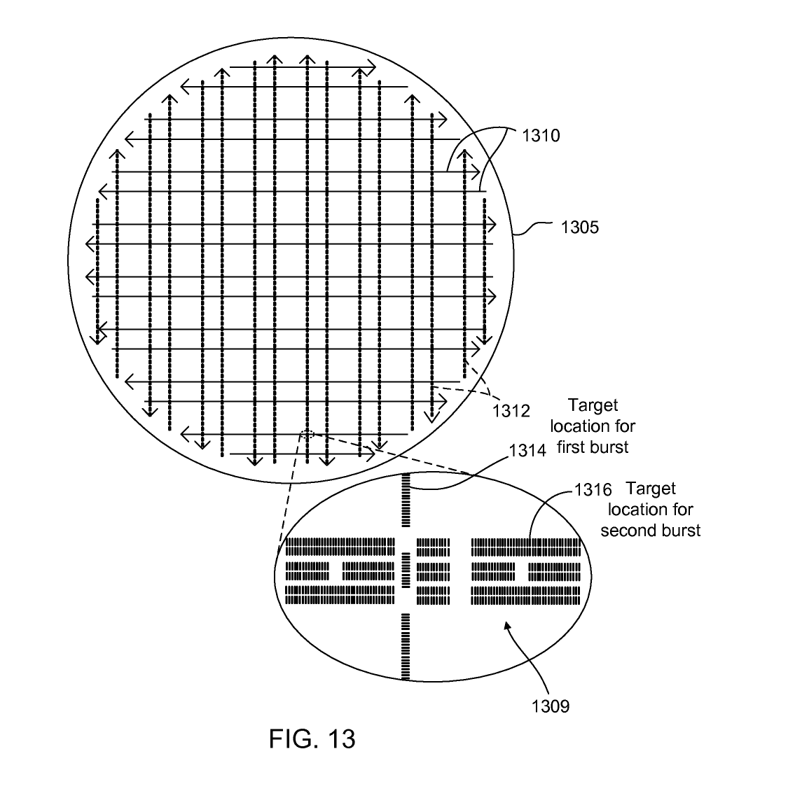

FIG. 13 schematically illustrates the processing of a wafer 1305 having electrically conductive links 1309 according to one embodiment. A sequential link blowing process includes scanning an XY motion stage (not shown) across the wafer 1305 once for each link run 1310. Repeatedly scanning back and forth across the wafer 1305 results in complete wafer processing. A machine typically scans back and forth processing all X-axis link runs 1310 (shown with solid lines) before processing the Y-axis link runs 1312 (shown in dashed lines). This example is merely illustrative. Other configurations of link runs and processing modalities are possible. For example, it is possible to process links by moving the wafer or optics rail. In addition, link banks and link runs may not be processed with continuous motion.

For illustrative purposes, a portion of the wafer 1305 near an intersection of an X-axis link run 1310 and a Y-axis link run 1312 is magnified to illustrate a plurality of links 1309 arranged in groups or link banks. During link processing, a first target location 1314 is illuminated with a first tailored burst 913 of laser pulses to blow a one of the links 1309. In this example, the first tailored burst 913 has a first polarization (e.g., radial polarization) selected based on a depth of the link structure at the first target location 1314. Then, a second target location 1316 is illuminated with a second tailored burst 913 of laser pulses to blow another link 1309. The second tailored burst 913 has a second polarization (e.g., azimuthal polarization) selected based on a depth of the link structure at the second target location 1316. The temporal power profile of each tailored burst 913 may be shaped as discussed above with respect to FIGS. 10A, 10B, or 10C. In one embodiment, the temporal power profile of each tailored burst is the same for each target location 1314, 1316. In another embodiment, the temporal power profile of the tailored burst 913 provided to the first target location 1314 is different than the temporal power profile of the tailored burst 913 provided to the second target location.

An artisan will recognize from the disclosure herein that many other target types and target features may be processed according to the embodiments herein. Further, the shape of each burst 913 may be dynamically selected based on the particular target type. Thus, devices with different target types may be processed with bursts 913 of laser pulses having different burst envelopes and/or different polarizations.

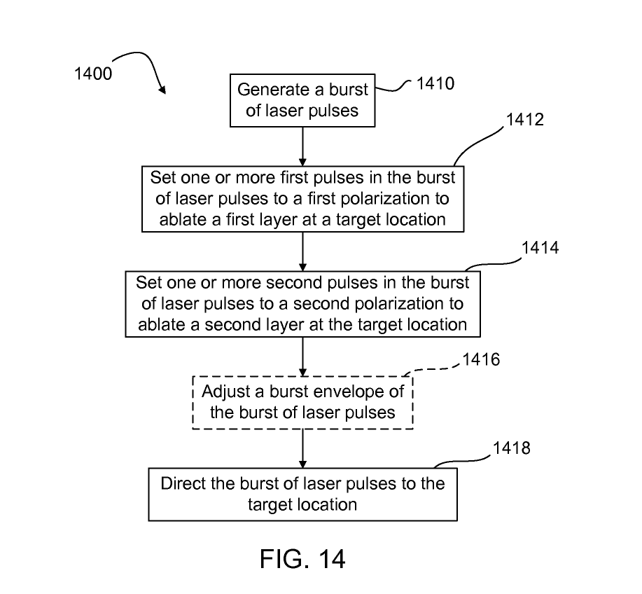

FIG. 14 is a flow chart of a method 1400 for laser processing with selective polarizations according to another embodiment. The method 1400 includes generating 1410 a burst of laser and setting 1412 one or more first pulses in the burst of laser pulses to a first polarization to ablate a first layer at a target location. As discussed above, selection of the first polarization may be based on the thickness of the first layer at the target location. The method 1400 further includes setting 1414 one or more second pulses in the burst of laser pulses to a second polarization to ablate a second layer at the target location. Again, selection of the second polarization may be based on the overall depth of the second layer (e.g., the thickness of the first layer added to the thickness of the second layer) at the target location. For example, the first laser pulse 1012 and the group of second laser pulses 1014 shown in FIG. 10A may be radially polarized to crack the upper passivation layer and ablate the electrically conductive link. The group of third laser pulses 1016 may be azimuthally polarized to clean out the deeper metallic residue. In certain embodiments, the method 1400 may further include adjusting 1416 a burst envelope of the burst of laser pulses (e.g., using an AOM or EOM as described above). The method 1400 further includes directing 1418 the burst of laser pulses to the target location.

Those having skill in the art will recognize from the disclosure herein that many changes may be made to the details of the above-described embodiments without departing from the underlying principles of the invention. The scope of the present invention should, therefore, be determined only by the following claims.

1. A laser-based processing method for removing target material from selected electrically conductive link structures of redundant memory or integrated circuitry, each selected link structure having opposite side surfaces and top and bottom surfaces, the top and bottom surfaces being separated by a distance that defines a link depth, the method comprising:
generating a burst of laser pulses;
selectively setting one or more first pulses in a first burst of laser pulses to a first polarization based on a depth of a first target link structure; and
directing the first burst of laser pulses to the first target link structure to ablate at least a first portion of the first target link structure.

2. The method of claim 1, further comprising:
selectively setting one or more second pulses in a second burst of laser pulses to a second polarization based on a depth of a second target link structure; and
directing the second burst of laser pulses to the second target link structure.

3. The method of claim 2, wherein the first polarization comprises radial polarization and the second polarization comprises azimuthal polarization, and wherein the depth of the first target link structure is less than the depth of the second target link structure.

4. The method of claim 1, further comprising:
before directing the first burst of laser pulses to the first target link structure, selectively setting one or more second pulses in the first burst of laser pulses to a second polarization to ablate a second portion of the target link structure.

5. The method of claim 4, wherein the first polarization comprises radial polarization and the second polarization comprises azimuthal polarization, and wherein the second portion of the link structure is deeper than the first portion of the link structure.

6. The method of claim 1, wherein the top surface of each selected link structure is adjacent overlying passivation material and the bottom surface of each selected link structure is adjacent underlying passivation material, the method further comprising:
selectively adjusting one or more of the first pulses in the first burst of laser pulses to a first amplitude selected so as to crack the overlying passivation material at top corners of the first target link structure without cracking the underlying passivation material; and
selectively adjusting a plurality of second pulses in the first burst of laser pulses at successively higher second amplitudes that ramp up so as to gradually heat the first target link structure above an ablation threshold,
wherein each of the respective second amplitudes is less than the first amplitude.

7. The method of claim 6, further comprising:
selectively adjusting a plurality of third pulses in the first burst of laser pulses at a constant third amplitude,
wherein the third amplitude is less than the first amplitude.

8. The method of claim 7, further comprising:
selectively adjusting a plurality of fourth pulses in the first burst of laser pulses at successively lesser fourth amplitudes that ramp down to remove a residue of the first target link structure.

9. A laser-based processing method for removing target material from selected electrically conductive link structures of redundant memory or integrated circuitry, each selected link structure having opposite side surfaces and top and bottom surfaces, the top and bottom surfaces being separated by a distance that defines a link depth, the method comprising:
generating a burst of laser pulses;
selectively setting one or more first pulses in the burst of laser pulses to a first polarization;
selectively setting one or more second pulses in the burst of laser pulses to a second polarization; and
directing the burst of laser pulses to a target link structure.

10. The method of claim 9, wherein the first polarization comprises radial polarization and the second polarization comprises azimuthal polarization, and wherein the one or more first pulses illuminate the target link structure before the one or more second pulses.

11. The method of claim 9, wherein the top surface of each selected link structure is adjacent overlying passivation material and the bottom surface of each selected link structure is adjacent underlying passivation material, the method further comprising:
selectively adjusting the one or more first pulses in the burst of laser pulses to a first amplitude selected so as to crack the overlying passivation material at top corners of the target link structure without cracking the underlying passivation material; and
selectively adjusting a plurality of the second pulses in the burst of laser pulses at successively higher second amplitudes that ramp up so as to gradually heat the first target link structure above an ablation threshold,
wherein each of the respective second amplitudes is less than the first amplitude.

12. The method of claim 11, further comprising:
selectively adjusting a plurality of third pulses in the burst of laser pulses at a constant third amplitude,
wherein the third amplitude is less than the first amplitude.

13. The method of claim 12, further comprising:
selectively adjusting a plurality of fourth pulses in the burst of laser pulses at successively lesser fourth amplitudes that ramp down to remove a residue of the target link structure.

14. A laser-based processing method for removing target material from selected electrically conductive link structures of redundant memory or integrated circuitry, each selected link structure having opposite side surfaces and top and bottom surfaces, the top and bottom surfaces being separated by a distance that defines a link depth, wherein the top surface of each selected link structure is adjacent overlying passivation material and the bottom surface of each selected link structure is adjacent underlying passivation material, the method comprising:
generating a burst of laser pulses;
selectively adjusting one or more first pulses in the burst of laser pulses to a first amplitude selected so as to crack the overlying passivation material at top corners of the target link structure without cracking the underlying passivation material;
selectively adjusting a plurality of second pulses in the burst of laser pulses at successively higher second amplitudes that ramp up so as to gradually heat the first target link structure above an ablation threshold, wherein each of the respective second amplitudes is less than the first amplitude; and
directing the burst of laser pulses to a target link structure.

15. The method of claim 14, further comprising:
selectively adjusting a plurality of third pulses in the burst of laser pulses at a constant third amplitude,
wherein the third amplitude is less than the first amplitude.

16. The method of claim 15, further comprising:
selectively adjusting a plurality of fourth pulses in the burst of laser pulses at successively lesser fourth amplitudes that ramp down to remove a residue of the target link structure.

17. The method of claim 14, further comprising:
selectively setting a polarization of the burst of laser pulses based on a depth of the target link structure.

18. The method of claim 14, further comprising:
selectively setting the one or more first pulses in the burst of laser pulses to a first polarization; and
selectively setting the plurality of second pulses in the burst of laser pulses to a second polarization.

19. The method of claim 18, wherein the first polarization comprises radial polarization and the second polarization comprises azimuthal polarization, and wherein the one or more first pulses illuminate the target link structure before the plurality of second pulses.
